(19) United States
(12) Patent Application Publication
(10) Pub. No.: US 2002/0102525 A1
(43) Pub. Date: Aug. 1, 2002

(54) System and method for coordinating the selection and delivery of educational services

(75) Inventor: Michael J. Coppolino, Acton, MA (US)

Correspondence Address: LAHIVE & COCKFIELD, 28 STATE STREET, BOSTON, MA, 02109, US

(73) Assignee: Trainease, Inc., Maynard, MA

(21) Appl. No.: 09/962,962

(22) Filed: Sep. 24, 2001

Related U.S. Application Data
(60) Provisional application No. 60/265,463, filed on Jan. 31, 2001.

(51) Int. Cl. G09B 3/00

(52) U.S. Cl. 434/350

(57) ABSTRACT

A method for the provision of educational services to trainees/company employees by educational content providers is disclosed. The illustrative embodiment of the present invention utilizes an application referred to as an educational intermediary to act as a conduit between the educational content provider and a trainee/company employeee. The educational intermediary provides real-time access to course offerings from a multitude of educational content providers from one centralized location.

### RELATED APPLICATION

This application claims priority to co-pending United States Provisional Application No. 60/265,463 filed Jan. 31, 2001, for all subject matter common to both applications. The disclosure of said provisional application is hereby incorporated by reference in its entity.

### TECHNICAL FIELD

The present invention relates generally to the field of providing educational services, and more particularly to the selection and provision of educational services using an educational intermediary.

### BACKGROUND

The explosion of new technology in the workplace has left employers with the difficult task of continually training and retraining their employees. Traditionally, the department of an employer having responsibility for employee training contacts an educational provider to determine what educational services are available. The process is repeated for another educational provider and continues until such time as all of the educational providers of which the employer is aware have been contacted. This approach has a number of problems. First, it requires the employer to make numerous phone calls or visit numerous web sites in order to obtain the desired information. Second, the approach is dependent upon the employer having a full listing of available educational providers. Third, the approach requires the employer to hope that by the time the employer has finished the process of contacting educational providers the information obtained from the educational providers has not become obsolete.

### BRIEF SUMMARY OF THE INVENTION

The illustrative embodiment of the present invention provides a method that enables a software facility interfaced with a network (referred to herein as an “educational intermediary”) to act as an intermediary between educational content providers and a prospective trainee/company employee, which are also interfaced with the network, in order to provide access to real-time listings of available educational services. The educational intermediary provides access to listings from multiple education training providers. Additionally, the method enables the educational intermediary to provide real-time confirmations of class reservation.

In one embodiment of the present invention, a host electronic device interfaced with a network includes a software facility known as an educational intermediary. The educational intermediary acts as an interface between at least one remotely located educational content provider and at least one remotely located company. The company has employees with continuing education needs. The software facility is used to list educational content offerings from the educational content provider on the electronic device. An employee from the company registers with the software facility and is then able to review and select one of the educational content offerings listed on the electronic device. In one aspect of the invention, a designated contact person for a previously registered company authorizes the selection of educational content offering made by the employee using the educational intermediary.

In another embodiment of the present invention a software facility operated by a company (the“educational intermediary”) is interfaced with a network and acts as an intermediary between at least one educational content provider and the company. The company has employees with continuing education needs, such as training in new computer languages. The educational intermediary lists educational content offerings available from the educational content provider. The educational content offering is educational content offered for delivery to a registered student/employee. An employee of the company is able to select an available educational content offering from the listing offered by the educational intermediary. In one aspect of the invention, a designated contact person for the company verifies the selection of educational content made by the employee using the educational intermediary.

### BRIEF DESCRIPTION OF THE DRAWINGS

FIG. 1 is a block diagram of an environment suitable for practicing the illustrative embodiment of the present invention;

FIG. 2 is a block diagram of an alternate environment suitable for practicing the illustrative embodiment of the present invention;

FIG. 3 is a flow chart depicting the sequence of steps involved in the course selection and reservation process of the present invention;

FIG. 4 is a flow chart depicting the sequence of steps followed by the illustrative embodiment of the present invention to retrieve updated listings of educational content offerings from educational content providers; and

FIG. 5 is a flow chart depicting the sequence of steps involved in the billing and course evaluation process of the present invention.

### DETAILED DESCRIPTION OF THE INVENTION

The illustrative embodiment of the present invention enables an educational intermediary to act as a conduit for the provision of educational services from an educational content provider to a prospective trainee/company employee. The educational intermediary provides access to up-to-date listings about the available educational offerings of the educational content providers and provides real-time confirmation of class reservation. Furthermore, the illustrative embodiment of the present invention enables an educational intermediary to obtain assessments and ratings of the quality of the educational courses from the trainee/company employee as well as providing an integrated billing method and cancellation policy.

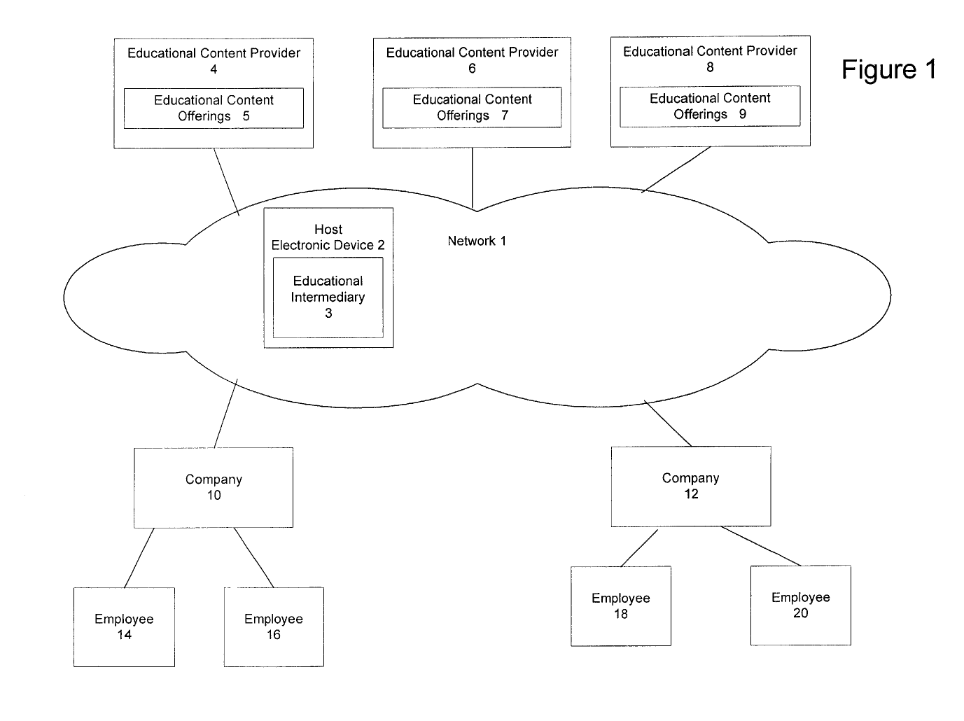

FIG. 1 is a depiction of an environment suitable for practicing the illustrative embodiment of the present invention. A software facility known as an educational intermediary 3 is located on a host electronic device 2 forming part of a network 1. A plurality of educational content providers 4, 6 and 8 are interfaced with the network 1. Each of the educational content providers 4, 6 and 8 have educational content offerings 5, 7 and 9. Also interfaced with the network 1 are a plurality of companies 10 and 12. The companies 10 and 12 each have employees 14 and 16, 18 and 20 with access to the network 1 through the companies. The educational intermediary 3 acts as a conduit for the provision of educational training services between the plurality of remotely located educational content providers 4, 6 and 8 and the remotely located companies 10 and 12 and their respective employees 14, 16, 18 and 20. The educational content offerings 5, 7 and 9 are educational content which is available for delivery from the educational content provider 4, 6 and 8 to an employee 14, 16, 18 and 20 from a company 10 and 12 that has registered with the educational intermediary 3. The companies 10 and 12 may enter into subscriber agreements with the operator of the educational intermediary 3, thereby enabling their employees to gain access to a listing of the educational content offerings 5, 7 and 9 available from the educational content providers 4, 6 and 8 in exchange for a periodically paid fee or a surcharge for each educational content offering 5, 7 and 9 selected by employees of the company. Alternatively, the operator of the educational intermediary 3 may reach agreement with the educational content providers 4, 6 and 8 to list educational content offerings 5, 7 and 9 from the educational content providers in exchange for receiving a portion of the fee paid to the educational content provider. The educational content providers 4, 6, 8 may also enter into subscription agreements with the operator of the educational intermediary 3 which requires the periodic payment of a fee.

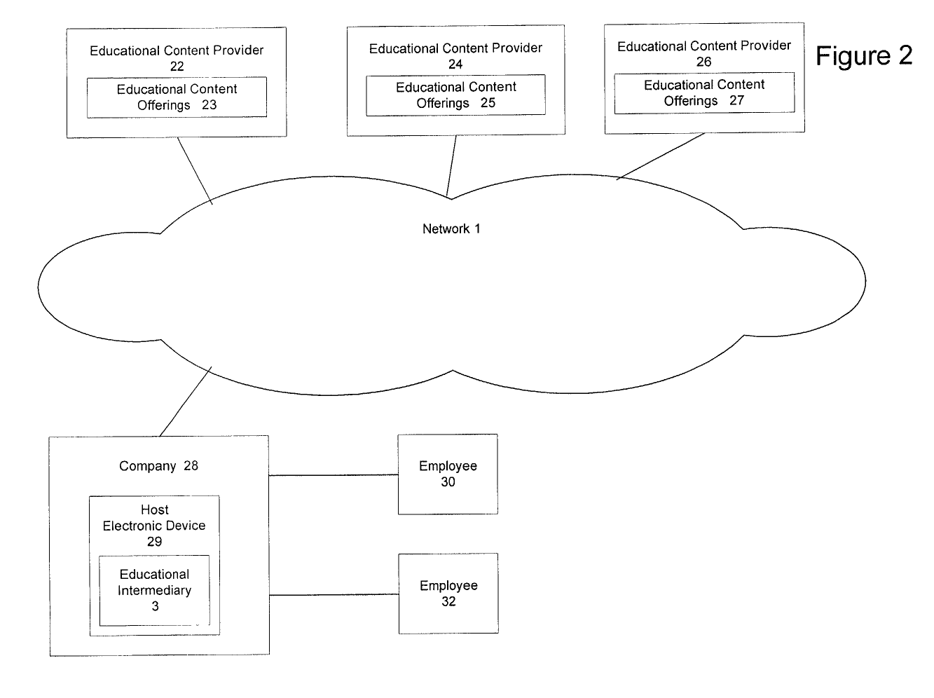

FIG. 2 depicts a block diagram of an alternate environment suitable for practicing the illustrative embodiment of the present invention where the educational intermediary 3 is a software application operated directly by a company. The educational intermediary 3 is located on an electronic device 29 operated by a company 28. The educational intermediary 3 may be a stand-alone application or part of a software suite. The producer of the educational intermediary software reaches subscription/fee sharing agreements with the educational content providers prior to selling the educational intermediary software to the company 28. The electronic device 29 is interfaced with a network 1. Also interfaced with the network 1 are a plurality of educational content providers 22, 24 and 26 having educational content offerings 23, 25 and 27. The employees 30 and 32 of the company 28 may select an educational content offering 23, 25 and 27 from a list provided by the educational intermediary 3.

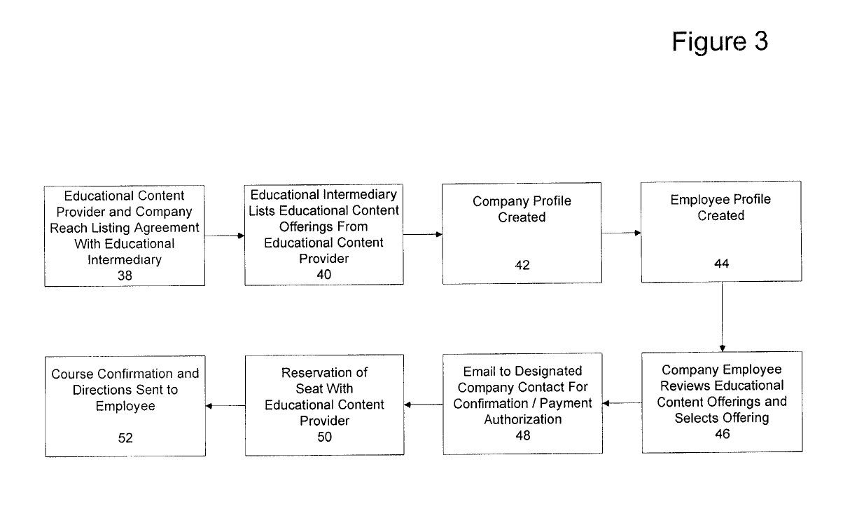

The course selection and reservation process utilized by the illustrative embodiment of the present invention varies depending upon who is controlling the operation of the educational intermediary. If the educational intermediary is being operated by a company directly, the subscription/fee sharing arrangement between the company, the educational content providers and the producer of the educational intermediary software is arranged prior to the company running the educational intermediary software. However, if a third party is operating the educational intermediary, the subscription/fee sharing agreements are determined at the outset of the course selection sequence. FIG. 3 represents a flow chart depicting the sequence of steps involved in the course selection and reservation process used when a third party operates the educational intermediary software. The sequence begins when the operator of the educational intermediary reaches a subscription or fee sharing agreement with the educational content providers and/or companies (step 38). The educational content providers gain the advantage of having their educational content offerings listed at a site with increased traffic, and the companies gain the advantage of being able to search in only one place to fulfill their employees continuing education needs. Those skilled in the art will realize that it is immaterial to the process whether a company or an educational content provider is the first to enter into a subscription agreement with the educational intermediary (although the particular course offerings from the particular educational content provider will not be available through the educational intermediary until after the educational content provider enters into the subscription agreement with the educational intermediary). The educational content offerings from the various educational content providers are listed by the educational intermediary (step 40). The process by which the information about the educational content offerings is acquired and listed by the educational intermediary is described in more detail below. Following the subscription agreement with the company (step 38), a company profile for the particular company is created (step 42) which includes a designated company representative or representatives with the authority to confirm employee attendance at courses and authorize payment for the courses. When an individual employee at a registered company wishes to receive training, or is directed to receive training, the employee first fills out a employee profile listing their pertinent employment data such as department, supervisor, etc. (step 44). The employee profile includes a user I.D. and a password. The employee accesses the educational intermediary website using the user I.D and password and is able to review and select courses offered by the educational content providers (step 46). A real-time listing of courses may be provided by the educational content provider instead of a static list. The information listed includes outlines, course descriptions and instructor information. Following the selection of a course by a trainee/company employee, an email is sent to the designated company representative for confirmation/payment authorization (step 48). Upon receipt of the confirmation/payment authorization, the educational intermediary reserves a seat for the trainee/company employee with the educational content provider offering the selected course (step 50). In the event the confirmation process was successfully completed, an email confirming the seat reservation along with directions for traveling to or accessing the course is then emailed to the particular trainee/company employee (step 52).

The educational intermediary 3 provides a listing of the available educational content offerings 5, 7 and 9 offered by the educational content providers 4, 6 and 8. When the terms of the subscription or fee sharing arrangement are negotiated with the educational content providers, a mechanism for updating the educational content offerings list is determined. When the educational content providers 4, 6 and 8 agree to allow the operator of the educational intermediary direct access to their data, the educational intermediary retrieves the listing information over the network directly from the computer system operated by the education content providers. The retrieval happens whenever an employee 14, 16, 18 and 20 of a company 10 and 12 requests information regarding educational content offerings. The retrieved information is real-time information which is as up to date as the information stored in the computer system for the education content providers 4, 6 and 8. If the educational content providers 4, 6 and 8 will not allow direct access to their computer systems, the educational intermediary 3 periodically receives the educational content offering information“pushed” over the network. The educational intermediary 3 lists the information received from educational content providers 4, 6 and 8 as a static list available for review by employees 14, 16, 18 and 20 of companies 10 and 12 registered with the educational intermediary. The information in the static list is updated only as frequently as the various educational content providers 4, 6 and 8 decide to push new information to the educational intermediary 3. The static method of listing available educational content still provides the benefits of a centralized location, but lacks the ability to provide real-time listings of educational content offerings.

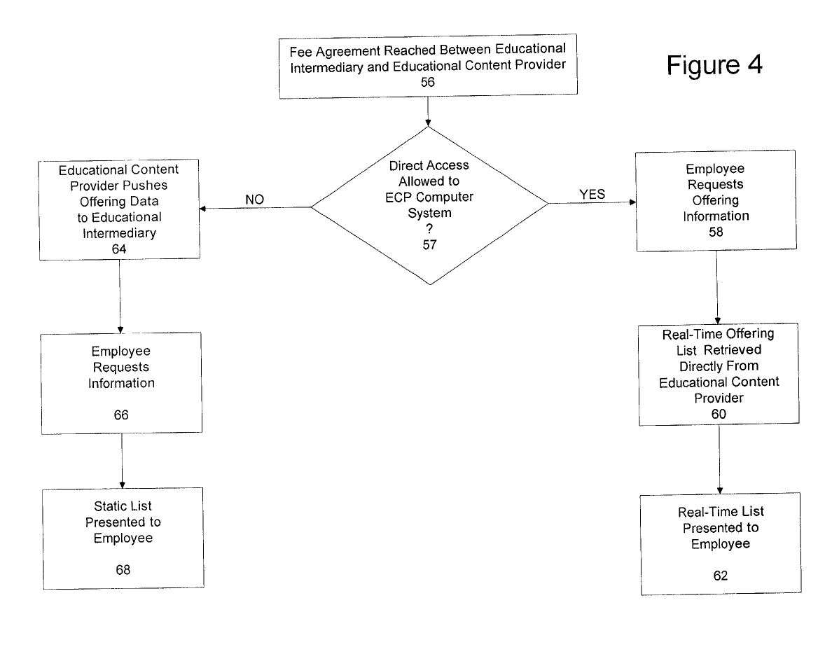

FIG. 4 is a flow chart depicting two methods used to retrieve information about educational content offerings from educational content providers. The sequence begins when the educational intermediary 3 and the educational content providers 4,6 and 8 reach a subscription or fee sharing agreement (step 56). As part of the agreement, it is determined whether the educational intermediary 3 will be allowed direct access to the computer systems of the educational content providers 4, 6 and 8 (step 57) in order to retrieve educational content offering information. If it is determined that the educational intermediary 3 will be allowed direct access to the computer systems of the educational content providers 4, 6 and 8 (step 57), then upon receiving an employee request for educational content offering information (step 58), the educational intermediary 3 retrieves the educational content offering information directly from the computer systems of the educational content providers (step 60). The retrieved real-time information is presented to the employee as a list of available educational content offerings (step 62). If it is determined that the educational intermediary 3 will not be allowed direct access to the computer systems of the educational content providers 4, 6 and 8 (step 57) a different sequence is followed to update the list of educational content offerings 5, 7 and 9. The educational content providers 4, 6 and 8 periodically push an updated list of their individual educational content offerings 5, 7 and 9 over the network to the educational intermediary 3 (step 64). The educational intermediary 3 saves the pushed data until receiving an employee request for educational content offering information (step 66) whereupon the saved list of educational content offerings is presented to the employee (step 68).

The educational content providers use a number of different methods for conveying information in their course offerings. The trainee may travel to another facility to receive in-person instruction. The educational content provider may deliver streaming video through a network directly to the desktop of the trainee. The educational content provider may also utilize web-based training to allow trainees to access web pages containing the content for a course offering. The illustrative embodiment of the present invention enables a company employee/prospective trainee to specify a particular form of content delivery at the time the search for course offerings through the educational intermediary is conducted. Only course offerings meeting the specified criteria will be listed for the company employee/prospective trainee. Additional criteria may include starting and completion dates, geographic restrictions on locations for in-person training, and subject matter.

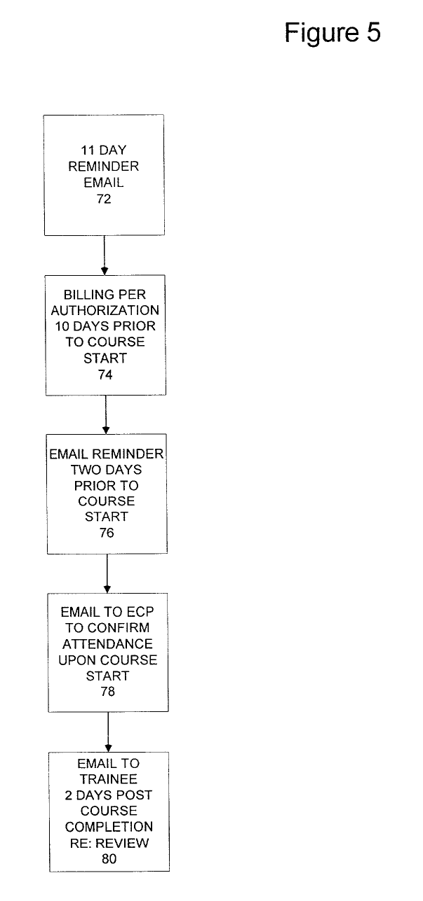

FIG. 5 depicts the billing and educational content offering evaluation process utilized by the illustrative embodiment of the present invention. As noted above, at the time of course selection, the designated company representative is emailed to provide payment authorization (step 48). Eleven days prior to the scheduled beginning of the class, a reminder email is sent out to the employee and the company representative (step 72). The next day, ten days prior to the scheduled beginning of the class, billing according to the terms of the previous payment authorization is executed (step 74). Two days prior to the start of the class, a reminder email is sent to the company (step 76). On the first day of class an email is sent to the educational content provider to confirm attendance of the trainee (step 78). Two days after the completion of the class the educational intermediary emails the employee to obtain course evaluation regarding the course offering (step 80). The evaluation received from the employee is utilized to provide course review information for future prospective class attendees. The evaluation provided to the educational intermediary from the trainee/company employee may be via email or alternatively by comments typed directly into a web page operated by the educational intermediary. The evaluation may contain ratings of the particular instructor and the particular course. If the employee course attendance is canceled more than 10 days prior to the scheduled beginning of the class, billing does not occur. If subsequent to the ten day billing notice the company/employee cancels course attendance, the company is charged for the class but receives a future credit good for one class in the next six months from any educational content provider course that is offered at the same rate as the canceled class.

The illustrative embodiment of the present invention also enables a company to quickly check the training status of all of its employees. By contacting the educational intermediary using a company code, an IT or Human Resources Manager for a company can quickly obtain data which provides a listing of all of the courses taken by a particular company employee. The educational status of an employee may include the amount of money spent on educational training for a particular employee. Additionally, the educational intermediary may track courses taken by a particular employee that fulfill professional accreditation requirements, such as courses to become a Microsoft Certified Systems Engineer (MCSE). The ability to obtain the up-to-date training status of company employees results in a time savings for the IT or Human Resources Manager who is not required to check with each individual employee.

In one embodiment of the present invention, a company submits an RFP/RFQ (Request for Proposal/Request for Quote) to the educational intermediary indicating attributes of educational training the company desires for its employees. The attributes may include training characteristics such as the desired location for training, method of content delivery, number of prospective students and dates of training. The educational intermediary obtains responsive educational content offerings from the educational content providers and presents the company with available training options responsive to the RFP/RFQ.

The illustrative embodiment of the present invention provides a one-stop educational clearinghouse for prospective educational trainees and their companies. It enables educational content providers to advertise course offerings to a multitude of companies through a single location run by an educational intermediary. Because the educational intermediary has access to a number of educational provider course offerings, the educational intermediary attracts a large volume of requests for information. The large volume of requests to the educational intermediary results in the opportunity for the educational content provider to receive more inquiries from prospective trainees then it would receive by running its own website.

It will thus be seen that the invention attains the objectives stated in the previous description. Since certain changes may be made without departing from the scope of the present invention, it is intended that all matter contained in the above description or shown in the accompanying drawings be interpreted as illustrative and not in a literal sense. Practitioners of the art will realize that the sequence of steps depicted in the figures may be altered without departing from the scope of the present invention and that the illustrations contained herein are singular examples of a multitude of possible depictions of the present invention.

We claim:

1. In a network, a method, comprising the steps of:
providing an educational intermediary between at least one remotely located educational content provider offering educational content and at least one remotely located company, said educational intermediary being a software facility located on a host electronic device and acting as an interface between said company and said educational content provider;
listing educational content offerings from said educational content provider with said educational intermediary, said educational content offerings being educational content offered for delivery to a registered employee of said company; and
receiving a selection of one of said educational content offerings listed on said educational intermediary, said selection made by an employee of said company.

2. The method of claim 1, comprising the additional step of:
charging a subscription fee to said company in exchange for providing access to the listing of educational content offerings on said educational intermediary.

3. The method of claim 1, comprising the additional step of:
charging a surcharge on a fee owed by said company to an educational content provider to an operator of said educational intermediary, said fee owed by said company for an educational content offering selected by said employee; and
sending said surcharge to said educational intermediary.

4. The method of claim 1, comprising the additional step of:
charging a subscription fee to said educational content provider in exchange for listing educational content offerings from said educational content provider on said educational intermediary.

5. The method of claim 1, comprising the additional step of:
sending to an operator of said educational intermediary, a portion of a fee paid to said educational content provider from said company, said fee paid by said company for an educational content offering selected by said employee.

6. The method of claim 1, comprising the further steps of:
receiving at said educational intermediary a listing of educational content offerings pushed from said educational content provider; and
listing statically at said educational intermediary said educational content offerings pushed from said educational content provider.

7. The method of claim 1, comprising the further step of:
retrieving with said educational intermediary a list of educational content offerings from said educational content provider in real-time; and
listing in real-time at said educational intermediary said list of educational content offerings retrieved from said educational content provider.

8. The method of claim 1, comprising the further step of:
registering a company profile with said educational intermediary, said company profile listing company information including a designated contact person at said company with authority to authorize employee training.

9. The method of claim 8, comprising the further steps of:
registering an employee profile with said educational intermediary for an employee of the company which registered said company profile, said employee profile including identifying information for said employee; and
allowing said employee access to the list of educational content offerings on said educational intermediary.

10. The method of claim 9, comprising the further steps of:
receiving at said educational intermediary a selection by said employee of at least one of said educational content offerings;
confirming said selection with said contact person; and
using said educational intermediary to reserve placement for said employee in a class for said educational content offering.

11. The method of claim 1, comprising the further steps of:
receiving at said educational intermediary at least one evaluation of said educational content offerings; and
listing said evaluation of said educational content offerings for review by said employee.

12. The method of claim 1 wherein said educational content offering is delivered via video to a registered student.

13. The method of claim 1 wherein said educational content offering is made available to a registered student on a web page.

14. The method of claim 1, comprising the further step of:
providing upon request to said company with said educational intermediary a listing of all of the educational content offerings taken by a selected employee of said company.

15. The method of claim 14, comprising the further step of:
indicating which of said educational content offerings satisfy professional certification requirements.

16. In a network, a method, comprising the steps of:
providing a software facility acting as an interface between at least one remotely located educational content provider offering educational content and a company, said software facility located on an electronic device operated by said company;
listing educational content offerings from said educational content provider on said electronic device using said software facility, said educational content offerings being educational content offered for delivery to employees of said company; and
receiving a selection of one of said educational content offerings with said software facility, said selection made by an employee of said company.

17. The method of claim 16, comprising the additional step of:
sending a portion of a fee owed by said company to an educational content provider to a manufacturer of said educational intermediary, said fee owed by said company for an educational content offering selected by said employee.

18. The method of claim 16, comprising the further steps of:
receiving at said educational intermediary a listing of educational content offerings pushed from said educational content provider; and
listing statically at said educational intermediary said educational content offerings pushed from said educational content provider.

19. The method of claim 16, comprising the further step of:
retrieving with said educational intermediary a listing of educational content offerings from said educational content provider in real-time; and
listing in real-time at said educational intermediary said educational content offerings retrieved from said educational content provider.

20. The method of claim 16, comprising the further steps of:
receiving with said software facility a selection by said employee of at least one of said educational content offerings;
confirming said selection with a contact person; and
using said software facility to reserve placement for said employee in a class for said educational content offering.

21. The method of claim 16, comprising the further steps of:
receiving with said software facility at least one evaluation of said educational content offerings by an employee of said company who previously selected and received one of said plurality of educational content offerings; and
listing said evaluation of said educational content offerings for review by other employees of said company.

22. In a network including a host electronic device, said host electronic device having a medium holding computer-executable instructions for a method, comprising the steps of:
providing an educational intermediary between at least one remotely located educational content provider offering educational content and at least one remotely located company, said educational intermediary being a software facility located on a host electronic device and acting as an interface between said company and said educational content provider;
listing educational content offerings from said educational content provider with said educational intermediary, said educational content offerings being educational content offered for delivery to a registered employee of said company; and
receiving a selection of one of said educational content offerings listed on said educational intermediary, said selection made by an employee of said company.

23. The medium of claim 22, said method, comprising the further steps of:
receiving with said software facility a selection by said employee of at least one of said educational content offerings;
confirming said selection with said contact person; and
using said software facility to reserve placement for said employee in a class for said educational content offering.

24. The medium of claim 22, said method, comprising the further steps of:
retrieving with said educational intermediary a listing of educational content offerings from said educational content provider in real-time; and
listing in real-time at said educational intermediary said educational content offerings retrieved from said educational content provider.

25. In a network, a method, comprising the steps of:
providing an educational intermediary between at least one remotely located educational content provider offering educational content and at least one remotely located company, said educational intermediary being a software facility located on a host electronic device and acting as an interface between said company and said educational content provider;
listing educational content offerings from said educational content provider with said educational intermediary, said educational content offerings being educational content offered for delivery to a registered employee of said company;
receiving an RFP (Request For Proposal) for educational training from said company with said educational intermediary, said RFP including attributes for said educational training; and
providing to said company from said educational intermediary a response to said RFP from said educational content provider, said response being a listing of said educational content offerings matching the attributes of the RFP.
